(19) United States
(12) Patent Application Publication
(10) Pub. No.: US 2014/0172215 A1
(43) Pub. Date: Jun. 19, 2014

(54) METHOD FOR DISTRIBUTING A REQUESTED TORQUE

(71) Applicant: Dr. Ing. h.c. F. Porsche Aktiengesellschaft, Stuttgart (DE)

(72) Inventors: Holger BARTELS, Aspach (DE); Leonardo Pascali, Moensheim (DE); Georg Mack, Eberdingen (DE); Malte Huneke, Leonberg (DE)

(73) Assignee: Dr. Ing. h.c. F. Porsche Aktiengesellschaft, Stuttgart (DE)

(21) Appl. No.: 14/107,475

(22) Filed: Dec. 16, 2013

(30) Foreign Application Priority Data
Dec. 17, 2012 (DE) 10 2012 112 418.3

(51) Int. Cl. B60W 10/119; B60W 10/08

(52) U.S. Cl. CPC B60W 10/119; B60W 10/08
USPC 701/22

(57) ABSTRACT

A method for distributing a requested torque to one or two drive axles of a vehicle, wherein the requested torque depends on a driver's request. For the first drive axle a first maximum value for a torque is calculated as a function of an adhesion limit of the first drive axle. For the second drive axle a second maximum value for a torque is calculated as a function of an adhesion limit of the second drive axle. At least a first portion of the requested torque is transmitted to the first drive axle, wherein the first portion does not exceed the first maximum value. A second portion of the requested torque is fed to the second drive axle if the first portion does not correspond to the requested torque, and wherein the second portion does not exceed the second maximum value, the requested torque is divided into the first portion and the second portion as a function of at least one parameter.

### CROSS-REFERENCE TO RELATED APPLICATIONS

This application claims priority of German Patent Application No. 10 2012 112 418.3, filed Dec. 17, 2012, which is incorporated by reference herein in its entirety.

### FIELD OF INVENTION

The invention relates to a method for distributing a requested torque for a vehicle having two drive axles.

### BACKGROUND

DE 10 2009 009 809 A1 discloses a drive device in which an internal combustion engine is provided for a first drive axle, and an electric drive unit is provided for a second drive axle of the vehicle. In addition, a differential is provided for the electric drive unit, which differential has a superimposed transmission unit. The operation of the drive unit can be omitted, for example, of the coefficient of friction of the road is too low.

### SUMMARY

The object of the invention is to improve a method for distributing a requested torque to two drive axles of a vehicle.

The object of the invention is achieved by a method for distributing a requested torque to one or two drive axles of a vehicle, wherein the requested torque depends on a driver's request, wherein for the first drive axle a first maximum value for a torque is calculated as a function of an adhesion limit of the first drive axle, wherein for the second drive axle a second maximum value for a torque is calculated as a function of an adhesion limit of the second drive axle, wherein at least a first portion of the requested torque is transmitted to the first drive axle, wherein the first portion does not exceed the first maximum value, wherein a second portion of the requested torque is fed to the second drive axle if the first portion does not correspond to the requested torque, and wherein the second portion does not exceed the second maximum value, wherein the requested torque is divided into the first portion and the second portion as a function of at least one parameter, by a computing unit designed to carry out the method, and by a computer program that is designed to carry out the method when it is run on a computing unit.

Further advantageous embodiments of the invention are disclosed in more detail herein.

The described method has the advantage that the first drive axle is supplied with a first portion of the requested torque, wherein the first portion does not exceed a first maximum value. The first maximum value is calculated as a function of the adhesion limit for the first drive axle. If the first portion is smaller than the requested torque, a second portion of the requested torque is transmitted to the second drive axle. The second portion does not exceed a second maximum value here. The second maximum value is calculated as a function of an adhesion limit for the second drive axle.

In this way, the requested torque is advantageously divided between the two drive axles without reaching the adhesion limit. Safe distribution of the requested torque between the two drive axles is therefore made possible. As a result, only a freely available longitudinal force potential is passed on to the front axle and rear axle. Provision of a maximum lateral force potential is ensured by taking into account the maximum values as a function of the adhesion limit of the drive axles. The division of the requested torque into the first portion and the second portion is carried out as a function of a parameter. As a result, optimum adaptation of the first and second portions is made possible.

In one embodiment, the parameter depends on efficient energy consumption. Depending on the selected driving situation the provision of drive to the first drive axle using an internal combustion engine may be more favorable or less favorable with respect to the energy consumption than the provision of drive to the second drive axle using an electric motor. As a result, the requested torque can be divided between the first portion and/or the second portion as a function of the efficient use of the internal combustion engine and/or of the electric motor.

In a further embodiment, the parameter can depend on an adhesion behavior of the drive axles. For example, when the adhesion limit at the first drive axle is reached, the first portion can be reduced and the second portion increased. Optimum provision of the requested torque is therefore made possible without a drive axle slipping.

In a further embodiment, the parameter depends on driving stability of the vehicle. For example, a load change in the vicinity of the adhesion limit as a result of an abrupt reduction in the driver's request can lead to the second portion being increased in order to promote the driving stability of the vehicle. However, the increasing of the first portion and the increasing of the second portion are in each case limited by the first or second maximum value being reached.

Furthermore, efficient energy consumption can comprise only the first drive axle which is driven, for example, by an internal combustion engine and the second drive axle, which is driven, for example, by an electric motor, is not being used. As a result, in particular in a driving situation in which the first portion corresponds to the requested torque without reaching the first maximum value, it may be advantageous not to provide drive to the second drive axle. As a result, the torque which is requested by the driver is made available, wherein energy is saved by using one drive axle.

In a further embodiment, the parameter depends on an operating parameter of the drive. This is advantageous, for example, if a separate drive is used for each drive axle. By taking into account an operating parameter of a drive it is possible to make the torque available in an optimum way, wherein, for example, as little energy as possible is consumed and/or as few pollutants as possible are generated. For example, an operating parameter can depend on an operating state of an energy source of the drive. If, for example, an internal combustion engine is used as a drive for the first drive axle and an electric motor is used for the second drive axle and if a battery is provided for supplying the electric drive with current, the state of charge of the battery can be taken into account in order to define the first portion and the second portion. For example, in the case of a low state of charge, the first portion can be increased at the cost of the second portion, and as a result the second portion can be kept low. As a result of the low second portion less current is also consumed and therefore the charging capacity of the battery is conserved.

In a further embodiment, the maximum values are calculated in real time. As a result, the first portion of the torque and the second portion of the torque can be matched precisely. In this context, it is possible, for example, to react quickly to brief changes in the adhesion limits.

In a further embodiment, a minimum value for the first portion of the torque and a minimum value for the second portion of the torque are calculated in real time. As a result, the first portion and the second portion each have to have the minimum value. As a result, simple and fast control of the portions is possible.

The newly described method has the advantage of being able to make available quickly and efficiently an optimally functioning distribution of the requested torque between two drive axles of a vehicle.

### BRIEF DESCRIPTION OF THE DRAWINGS

An exemplary embodiment of the invention will be explained in more detail with reference to the figures, in which:

FIG. 1 shows a schematic illustration of a vehicle,

FIG. 2 shows a schematic illustration of the method for distributing the requested torque to two drive axles of a vehicle,

FIG. 3 shows a torque diagram as a function of the time, and

FIG. 4 shows a torque diagram as a function of a lateral acceleration of the vehicle.

### DETAILED DESCRIPTION

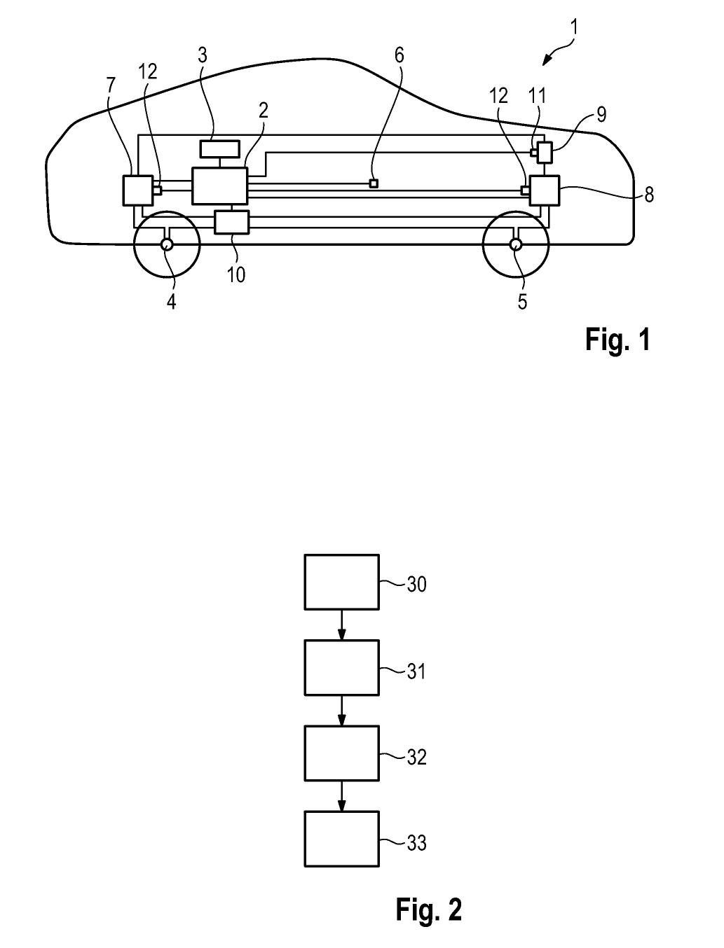

FIG. 1 shows a schematic illustration of a vehicle 1. The vehicle 1 has a first drive axle 4 and a second drive axle 5. Each drive axle has two wheels which are only illustrated schematically in the figure. In addition, a computing unit 2 is provided which is connected to a memory 3. Furthermore, a sensor 6 is provided which is connected to the computing unit 2. The sensor 6 can be provided therewith, for example, for sensing a driver's request. For example, the sensor 6 can sense an accelerator pedal position of the vehicle. In addition, a first drive 7 and a second drive 8 are provided, wherein the drives 7, 8 are each connected to the computing unit 2. The first drive 7 is connected, for example via a distributor unit 10, to the first and second drive axles 4, 5 depending on the selected embodiment. In a further embodiment, the first drive 7 can only be connected directly to the first drive axle 4. The first drive axle 4 constitutes, for example, the rear axle. The second drive 8 is connected, for example via the distributor unit 10, to the first and second drive axles 4, 5 depending on the selected embodiment. The second drive 8 can also only be operatively connected to the second drive axle 5 in a direct fashion, depending on the selected embodiment. The second drive axle 5 constitutes the front axle.

The first drive can be embodied as an internal combustion engine and/or as an electric motor depending on the selected embodiment. Likewise, the second drive 8 can be embodied as an internal combustion engine and/or as an electric motor. In addition, the drives 7, 8 can also constitute any other type of drive.

In order to operate the vehicle 1, the computing unit 2 senses, for example by means of the sensor 6, a driver's request relating to a requested torque with which the vehicle 1 is to be moved. Subsequently, the computer unit 2 actuates the first and/or second drives 7, 8 as a function of the sensed requested torque. The first and second drives 7, 8 transmit a corresponding torque to the distributor unit 10 or directly to the first drive axle 4 or to the second drive axle 5 as a function of the actuation by the computing unit 2.

If the torques of the first and second drives 7, 8 are transmitted to the distributor unit 10, the computing unit 2 controls the distribution of the torque via the distributor unit 10 to the first and/or to the second drive axles 4, 5 as a function of a defined method.

Furthermore, for example an energy source 9 is provided which can supply the first and/or the second drive 7, 8 with energy. In addition, a second sensor 11 is provided which is assigned to the energy source 9 and senses an operating parameter of the energy source 9. The second sensor 11 is connected to the computing unit 2. An operating parameter of the energy source 9 can constitute, for example, the energy stored in the energy source 9. If the energy source 9 is embodied as a battery, the operating parameters constitute, for example, the voltage and/or a current which is made available to the first and/or the second drive 7, 8. The charging capacity of the battery can be estimated by the computing unit 2 as a function of the voltage and/or the current.

In addition, data and/or characteristic curves which relate to the first and the second drive 7, 8 and which represent operating parameters of the first and second drives 7, 8 are stored in the memory 3. In addition, the computing unit 2 can sense current operating parameters of the drives 7, 8 by means of corresponding further sensors 12 which are assigned to the first and second drives 7, 8.

FIG. 2 shows a schematic illustration of program steps for carrying out the method.

In the case of program point 30, the computing unit 2 calculates, for example in real time, utilization of the coefficient of friction at the first drive axle 4, that is to say at the rear axle 5. In addition, the computing unit 2 calculates utilization of the coefficient of friction at the second drive axle 5, that is to say at the front axle.

In the case of a following program point 31, the computing unit 2 calculates a minimum value and a maximum value for a permissible drive torque of the first drive axle 4 and of the second drive axle 5 on the basis of the utilizations of the coefficients of friction of the front axle and of the rear axle. At a following program point 32, the computing unit 2 senses the driver's request with respect to a requested torque which is to be output to the first and the second drive axle 4, 5.

At a following program point 33, the computing unit 2 divides the requested torque into a first portion to be output to the first drive axle 4 and/or into a second portion to be output to the second drive axle 5, as a function of at least one parameter. In this context, it is taken into account, for example as a parameter, that one of the two drive axles 4, 5 is used as a primary drive axle and the other drive axle 4, 5 is used as a secondary drive axle. The first drive axle is used, for example, to output the requested torque insofar as this is possible without using the second drive axle. The use of the second drive axle is then necessary, for example when a parameter indicates that the use of the second drive axle is then advantageous. The use of the second drive axle is advantageous, for example, when the requested torque is so large that the first portion is larger than a first maximum value. The first maximum value defines the maximum torque which can be output via the first drive axle as a function of the prevailing operating conditions of the vehicle. In this case, the first portion of the torque is limited to the maximum value and the second portion is correspondingly increased, and torque is also output via the second drive axle. To do this, the drives 7,8 and/or the distributor unit 10 are correspondingly actuated by the computing unit 2.

A further parameter which causes torque to be output via the second drive axle 5 can depend on the fact that the outputting of the torque via the second drive axle 5 brings about more efficient consumption of energy. In addition, depending on the present driving situation it may also be advantageous to apply torque only to the first drive axle 4. This is the case, for example, when the vehicle is traveling straight ahead, the first drive axle 4 constitutes the rear axle and the requested torque of the driver is below the first maximum value for the first drive axle. In a normal driving situation, the use of just one drive axle permits lower consumption of energy than the use of two drive axles.

For example, spinning of the first drive axle 4 can lead to a situation in which, in order to achieve the requested torque, a second portion of the torque is output to the second drive axle, and/or the second portion is increased for the second drive axle. In this situation, in order to improve the driving stability and/or to achieve the requested torque the torque which is output via the second drive axle 5 is increased despite increased consumption of energy.

The computing unit 2 therefore divides the requested torque in a fixed fashion into the first portion for the first drive axle and/or into the second portion for the second drive axle as a function of the parameter which can depend, for example, on efficient consumption of energy and/or on an adhesion behavior of the drive axles and/or on driving stability of the vehicle and/or on an operating state of the drives 7, 8 and/or on an operating state of an energy source 9 of the drives 7, 8.

In a further embodiment, the computing unit 2 can also take into account a minimum value for the torque which is fed to the first drive axle and the second drive axle 4, 5. The minimum value of the torque for the drive axles 4, 5 may depend, for example, on the driving stability of the vehicle. If, for example, the first drive axle spins, the computing unit 2 calculates, for the second drive axle, a minimum value of the torque which can be as much as the requested torque. However, the adhesion limit of the second axle is prevented from being reached by taking into account the maximum value.

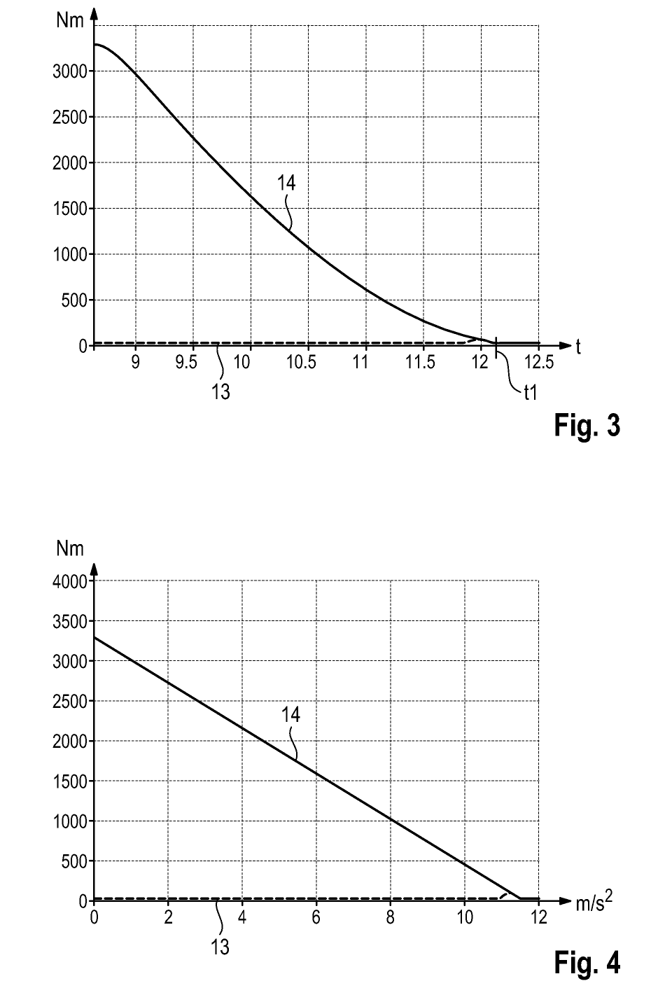

FIG. 3 shows a diagram for a driving situation in which the minimum value 13 which is calculated by the computing unit 2 and the maximum value 14 for the second drive axle 5 are illustrated. The minimum value 13 and the maximum value 14 are plotted in the form of characteristic curves against the time t. The driving situation relates to cornering at a speed of 100 km/h in which the steering wheel is deflected to the left with a constant angular speed of 30° per second. Owing to the lateral acceleration of the vehicle, the maximum torque which can be output via the second drive axle 5 is reduced, at the time 0 seconds, from an absolute value of 3500 Newton meters (Nm) continuously to virtually a value 0 at a time t1. The minimum value 13 remains virtually 0 Nm starting from the starting point t0 up to just before the first time t1 is reached. Just before the first time t1 is reached, a load change is brought about by the driver in that the driver abruptly reduces the requested torque, that is to say takes his foot off the accelerator pedal. As a result, the tires of the first drive axle, that is to say of the rear axle, are abruptly relieved of load. This leads to a situation in which, in order to reduce the load change reaction, the computing unit 2 increases the minimum value 13 for the second drive axle 5 to a value of, for example 60 Nm. The minimum value can, however, only be raised as far as the maximum value 14 by the computing unit 2. If the maximum value is reached, no drag torque can be transmitted anymore via the second drive axle 5 in order to stabilize the vehicle.

FIG. 3 shows the same driving situation in which the minimum value 13 and the maximum value 14 of the torque for the second drive axle 5 are plotted against a lateral acceleration of the vehicle in m/s². The maximum value 14 also drops here continuously. In addition, the minimum value 13 remains at 0 Nm until just before the time before the maximum value 14 also reaches the value 0 Nm.

When the maximum value for the first portion of the torque for the first drive axle 4 is reached, the computing unit 2 can use a transition function to increase the second portion of the torque for the second drive axle 5. The transition function may be implemented, for example, in a characteristic curve with a linear gradient. It is therefore possible, when the maximum value for the first portion is approached, that even before the maximum value is reached the second portion of the torque is continuously increased as the distance between the first portion and the maximum value decreases. Therefore, this ensures that the first portion does not exceed the first maximum value. Furthermore, it is ensured that the second portion for the second drive axle does not increase abruptly. As a result, the driving stability is improved and the sensation of comfort of the driver increases. Furthermore, abrupt load changes are avoided. In an analogous fashion, the adaptation can also be carried out when there is a changeover of the torque distribution from the second drive axle to the first drive axle.

In order to calculate a minimum value for the torque on a drive axle it is possible to take into account the fact that the first portion of the first drive axle, that is to say of the rear axle, is relieved of loading according to requirements, for example at the slip limit or in the case of a load change. As a result, a torque is shifted to the second drive axle, that is to say to a second portion for the second drive axle, as a function of the torque on the first drive axle. For this purpose, a function can be used which, when the first portion approaches the maximum value of the maximum possible torque of the first drive axle, transmits a portion of the requested torque to a second portion for the second drive axle 5. When the first portion approaches the maximum value, the second portion can be increased, for example, linearly.

The function has, for example, a factor which can assume a value between 0 and 1. For example, starting from a value of the torque on the first drive axle 4 of 80% of the maximum value the factor can increase from a value 0 linearly to the value 1 for the torque on the first drive axle of 100% of the maximum value.

The maximum value for the torque of a drive axle can be calculated, for example, according to the following formulas:
1.) Determination of the coefficient of friction of the road which is present by means of the relationship

$${μ}_{ma x} = \sqrt{{a}_{x}^{2} + {a}_{y}^{2}} \cdot \frac{1}{g}$$

2.) Determination of the utilization of the coefficient of friction at the wheels of the secondary axle

$${μ}_{y , used , Vi} = \frac{{F}_{yVi}}{{F}_{{zVi}^{{μ}_{Pot , Vi}}}}$$

$$l = l , r$$

2.1) Calculation of the secondary axle wheel loads (here the front axle wheel loads) on the basis of the longitudinal and lateral load transfer

$${F}_{zVi} = {F}_{zStatVi} \pm {C}_{Lat} {a}_{y} - {a}_{x} {C}_{Long} , \\ i = l , r$$

$${C}_{Long} = 0.5 \frac{mh}{l}$$

$${C}_{Lat} = f ( m , h , height of the rolling center , width of lane , etc . )$$

2.2) Calculation of the lateral forces at the secondary axle (VA here) on the basis of the weight distribution, the lateral acceleration present and the lateral load transfer

$${F}_{yVA} = {m}_{VA} {a}_{y}$$

$${F}_{zVA} = {F}_{zVI} + {F}_{zVr}$$

$${F}_{yVi} = {F}_{yVA} = \frac{{F}_{zVi}}{{F}_{zVA}}$$

1) Calculation of the longitudinal force potential on the inside of the bend and outside of the bend

$${F}_{xPot , Vi} = {F}_{zVi \sqrt{{μ}_{Pot}^{2} - {μ}_{y , used}^{2}}}$$

2) Calculation of the torque (maximum permitted torque at the VA without disrupting the utilization of the lateral force)

M_{xPot,Vi}=F_{xPot,Vi}r_{stat,Vi}

For the formulas, the following parameters were used: μₘₐₓ for the maximum coefficient of friction of the road; aₓ for the lateral acceleration in the X direction, that is to say in the longitudinal direction; a_{y} for the lateral acceleration in the Y direction, that is to say laterally with respect to the vehicle; g for the acceleration due to gravity; μ_{y} for the coefficient of friction in the Y direction; F_{yVi} for the lateral force in the Y direction; F_{zVi} for the force in the longitudinal direction; μ_{Pot,Vi} for a possible coefficient of friction potential; i as an index for the left-hand wheel or the right-hand wheel.

F_{zStatVi} represents the static wheel load; C_{Lat} a factor for the lateral acceleration which is, for example, a function of the mass m, the height h of the center of gravity, the height of the rolling center, the wheel track and so on. l denotes the wheel base; m the mass, h the height of the center of gravity of the vehicle; F_{yVA} the lateral acceleration in the Y direction for the front axle; m_{VA} is the mass of the front axle; F_{zVA} is the longitudinal acceleration of the front axle; F_{ZVl} is the force in the longitudinal direction of the left-hand wheel; F_{zVR} is the vertical acceleration for the right-hand wheel; F_{yVi} is a further load; F_{xPot,Vi} is the longitudinal force potential for the inside of the bend and outside of the bend; μ_{Pot} is the potential frictional engagement, M_{xPot,Vi} is the maximum permitted torque at the front axle.

1. A method for distributing a requested torque to one or two drive axles of a vehicle, wherein the requested torque depends on a driver's request, wherein for the first drive axle a first maximum value for a torque is calculated as a function of an adhesion limit of the first drive axle, wherein for the second drive axle a second maximum value for a torque is calculated as a function of an adhesion limit of the second drive axle, wherein at least a first portion of the requested torque is transmitted to the first drive axle, wherein the first portion does not exceed the first maximum value, wherein a second portion of the requested torque is fed to the second drive axle if the first portion does not correspond to the requested torque, and wherein the second portion does not exceed the second maximum value, wherein the requested torque is divided into the first portion and the second portion as a function of at least one parameter.

2. The method as claimed in claim 1, wherein the parameter depends on efficient energy consumption.

3. The method as claimed in claim 1, wherein the parameter depends on an adhesion behavior of the drive axles.

4. The method as claimed in claim 1, wherein the parameter depends on driving stability of the vehicle.

5. The method as claimed in claim 1, wherein two drives are used to make available the torque for the two drive axles, wherein in each case one drive is assigned to one drive axle, and wherein the parameter depends on an operating parameter of the drive.

6. The method as claimed in claim 5, wherein an energy source is provided for a drive, wherein the parameter depends on an operating state of the energy source.

7. The method as claimed in claim 6, wherein the drive has an electric motor, wherein the energy source is a battery, and wherein the operating parameter is a state of charge of the battery.

8. The method as claimed in claim 5, wherein the first drive is an internal combustion engine and the second drive is an electric motor, wherein the internal combustion engine only drives the first drive axle, and the electric motor only drives the second drive axle.

9. The method as claimed in claim 1, wherein the maximum values of the torques are calculated in real time.

10. The method as claimed in claim 1, wherein minimum values for the first portion and the second portion are calculated as a function of a parameter, and wherein at least the minimum value of the torque is respectively applied to the first and second drive axles as long as the minimum value does not exceed the maximum value.

11. The method as claimed in claim 10, wherein the minimum values are calculated in real time.

12. The method as claimed in claim 1, wherein, when the first portion approximates to the first maximum value, the second portion is increased using a transition function of the distance of the first portion from the maximum value.

13. A computing unit which is designed to carry out the method as claimed in claim 1.

14. A computer program which is designed to carry out the method as claimed in claim 1 when it is run on a computing unit.
